(19) United States
(12) Patent Application Publication
(10) Pub. No.: US 2014/0149287 A1
(43) Pub. Date: May 29, 2014

(54) System and Method for Donating Money Using a Mobile Electronic Device

(71) Applicant: Olawale Mafolasire, Indianapolis, IN (US)

(72) Inventor: Olawale Mafolasire, Indianapolis, IN (US)

(21) Appl. No.: 13/888,274

(22) Filed: May 6, 2013

Related U.S. Application Data
(60) Provisional application No. 61/687,950, filed on May 5, 2012.

(51) Int. Cl. G06Q 20/10; G06Q 20/32

(52) U.S. Cl. CPC G06Q 20/10; G06Q 20/322
USPC 705/44

(57) ABSTRACT

This invention allows a patron at an event who is without cash to donate money using a mobile electronic device. The invention is a mobile electronic-device based method for sending money from a donor to a donee. Location detecting means detect the location of the donor's mobile electronic device and the locations of possible donees in close proximity to the mobile electronic device. The donor may additionally search for donees who are not in close proximity to the mobile electronic device and donate to them. The donor is prompted to choose its intended donee, prompted to enter validating information, and prompted to select the intended donation amount. Upon sending the money it is routed through a mobile application and a website application, at which time the funds are deducted from the donor's account and a barcode receipt is generated. The funds are then routed to the donee's account.

### CROSS REFERENCE TO RELATED APPLICATIONS

This application claims priority from U.S. Provisional Application 61/687,950, titled a System and Method for Donating Money Using a Mobile Electronic Device, filed on May 5, 2012, the entirety of which is hereby incorporated by reference.

### STATEMENT REGARDING FEDERALLY SPONSORED RESEARCH

Not Applicable

### BACKGROUND OF THE INVENTION

This invention pertains to a system and a method of using a mobile electronic device to donate money to a recipient, for example, a house of worship or a non-profit organization. Many worshippers attend their places of worship and desire to donate money by giving their tithes or offerings. Unfortunately, a significant number of these worshippers either forget to bring cash or their checkbooks. Therefore, they cannot donate money if they so desire.

Many places of worship collect tithes and offerings by passing an offering container around so that worshippers can donate their offering by placing money in the container. During offering time, when the offering container is handed to the worshipper who forgot to bring cash or check, he or she is often embarrassed because of his or her inability to put money in the offering container. Other places of worship collect offerings by ushering worshippers from their seats to the front of the altar where an offering container is placed. The worshipper then donates money by placing the money in the container as the worshipper moves past the container. As you might expect, the worshipper who forgot to bring cash or check usually does not partake in the procession to the altar because he or she wants to avoid the embarrassment attendant to dancing past the altar without dropping an offering in the offering container; or the worshipper just dances past the altar and is embarrassed when he or she does not drop a donation in the container in front of the altar. This incident has caused many places of worship to lose out on substantial revenue, caused a great deal of embarrassment to forgetful worshippers, and even made some worshippers feel guilty of stealing from God.

Furthermore, many patrons attend fundraising events and are asked to donate money at the end of the event. Many of these patrons, as you might expect, do not have their checkbooks or are without sufficient cash to complete a donation. The event administrators typically hand out pledge cards and ask that these patrons pledge to make a future donation.

To that end, there is a pressing need for a system through which worshippers can donate their offerings at their respective places of worship in the event that the worshipper forgets to bring some cash or check. Responding to that need, this application discloses a system and a method using a mobile electronic device through which worshippers can donate money during worship hours or at any other time in the event that they forget to bring cash or check. This invention also allows patrons who have pledged to make a future donation to conveniently fulfill their pledges through the comfort of their mobile electronic device. This is a win-win situation both for the donor and the recipient.

Before discussing further, there are several prior art that disclose methods of sending money using a mobile device, but none of them have addressed the specific need of enabling worshippers to donate money through their mobile device and, at the same time, generating a barcoded receipt that worshippers scan under a barcode-reading device. The barcoded receipt contains encrypted details of the donation, including identification of donor, amount and time stamp of donation, name of donee, and reason for donation. When donors scan the barcoded receipt, they effectively notify the place of worship and fellow worshippers that they have made their donation.

Methods of paying through a mobile device have been disclosed in several prior art. Chang, U.S. 2010/0009663, Adiseshann, U.S. 2010/0185544, and Mizrah, U.S. 2011/0035294. Chang discloses a method for paying with a mobile phone device where the payer inputs his credit card information in a system that is wirelessly connected to a credit card terminal. A barcode is generated that has the encrypted credit card information of the payer and it is wirelessly transmitted to the credit card terminal, where it is decoded and validated. Adiesesham discloses a method for sending payments with a mobile device where the payer sends a text message containing identifying information to a proxy and the proxy debits the money from the account of the payer and sends it to the payee. Mizrah practically discloses a method of payment between a buyer and a seller where an authorization is obtained from the buyer, seller, and their respective banks to commit to payment. After authorization, a “pre-authenticated” transaction clearance code is generated as proof of the buyer's right to claim the goods and proof of the seller's right to receive payment. The method disclosed in this application, however, differs from the foregoing references.

In the method disclosed in this application, the worshippers download an application on their mobile device and register online. Once the worshippers donate money to the donee, a barcode of the receipt of their payment is generated in the screen of their mobile device. The worshippers then take the barcode on the screen of their mobile device to a barcode scanning device where it can be scanned, which symbolizes donating money. This act of the worshipper scanning the barcode receipt on a scanning device mimics the symbolic act of placing money in the offering bag or the symbolic act of placing money in a container in front of the altar, depending on the place of worship's style of accepting donations. The method also tallies all the scanned bar codes and automatically records the total amount of donations received, mimicking the act of tallying tithes and offering after they have been collected. This system and method enables forgetful worshippers to still donate money in the event they forget to bring cash to their houses of worship, thereby eliminating the embarrassment attendant to not placing money in the offering container and the guilt attendant to not giving to God. This system and method also helps the place of worship eliminate the inefficiencies associated with manually counting moneys collected from tithes and offerings. During fund raising events (political or NPO), this system and method provides a way through which a donee can receive cashless donations at a time when the mission's message is freshest on the donor's mind.

### BRIEF SUMMARY OF THE INVENTION

It is an object of this invention to overcome the disadvantages and limitations of the prior art.

An object of this invention is to provide a system and method for using a mobile electronic device to donate money to any recipient.

Another object of this invention is to provide a system and method for using a mobile electronic device to donate money from a donor to a recipient who is distant from the donor.

Another object of this invention is to provide a system and method for using a mobile electronic device to donate money from a nonregistered donor to a registered donee. This system/method uses the location detection capabilities in the donor's mobile device to detect the premises of the registered donee when the nonregistered donor enters the premises of the registered donee, whereupon the nonregistered donor is prompted to download the mobile application and donate money to the registered donee.

Yet another object of this invention is to provide a system and method for using a mobile electronic device to donate money from a registered donor to a nonregistered donee. The registered donor enters the premises of a nonregistered donee, and the registered donor is prompted to donate money to the nonregistered donee.

Still another object of this invention is to provide a system and method for using a mobile electronic device to donate money from a nonregistered donor to a nonregistered donee. The system and method uses the location detection capabilities in the mobile device of the nonregistered donor to detect the premises of the nonregistered donee when the nonregistered donor enters the premises of the nonregistered donee.

In a related embodiment of this invention, the donee is a church, place of worship, a fundraising organization, or a fundraising activity at a physical location.

In a related embodiment of this invention, the donee's premises is verified through Google Maps.

In another related embodiment of this invention, the donee's premises is verified through Yellow Pages location technology.

In yet another related embodiment of the present invention, the donee's premises is verified through a combination of the phone's GPS, location report from the wireless service provider (such as AT&T, Verizon), and public IP addresses to determine the location of the mobile device.

In another related embodiment of this invention, a report containing a record of all the donor's donations is generated and sent to the donor.

In another related embodiment of this invention, a report containing a record of all the donations received by donee is generated and sent to the donee.

A mobile electronic device-based method for sending money from a donor to a donee, said method comprising the steps of detecting the location of a mobile electronic device using means for detecting location; detecting the locations of a donees that are in proximity of said mobile electronic device using means for detecting location and populating the list of said donees so that it is visible to said donor on said donor's mobile electronic device, wherein said donor is prompted to select the intended donee from said populated list and thereafter prompted to select the donation denomination, a validating information, and a donation amount from a plurality of donation amounts; routing said donation amount first through a mobile application and then through a website application and, if said donation amount is approved, said donation amount is collected from donor's bank account and updated in donor's donation history; generating a barcode receipt on the screen of said mobile electronic device so that is visible to the donor, depositing the donation amount to a registered depository less commission and fees, and sending a secured deposit bulk file web link to the donee for download or export; and notifying said donee of said secured deposit bulk file web link via means for notifying and prompting said donee to access said link via a username and password and, upon a successful login, updating said donee's accounting system, reconciling each barcode receipt with the bulk file information, and adding donor's name to donee's donor directory.

### DEFINITION OF TERMS

a. A “registered donor” is a donor who has been approved by the system administrator to donate. A registered donor is approved when he has downloaded the application to his mobile device, submitted the required information to the system administrator, had his/her identity confirmed, and received an approval confirmation from the system administrator.
b. A “nonregistered donor” is a donor who has not had his or her identity confirmed and has not been approved by the system.
c. A “registered donee” is an entity that has been approved by the system administrator to receive donations. A registered donee is approved when he has submitted his registration identification and bank information to the system administrator and received an approval confirmation from the system administrator.
d. A “nonregistered donee” is an entity that has not been approved by the system administrator to receive donation.

### BRIEF DESCRIPTION OF SEVERAL DRAWINGS OF THE INVENTION

FIG. 1 is a schematic representation of a scenario where a registered donor enters the premises of a registered donee and is prompted to donate money. The system/method leverages the GPS and wireless carrier location reports in the registered donor's mobile device in detecting the premises of the registered donee, and the registered donor simply donates money that will be later sent to the registered donee.

FIG. 2 is schematic representation of a scenario where a nonregistered donor enters the premises of a registered donee. The system/method leverages location detection capabilities in the nonregistered donor's mobile device in detecting the premises of the registered donee, and the nonregistered donor is prompted to download the application and donate money. After the nonregistered donor donates the money, he is directed to a link where he can submit his registration information. The money is later sent to the registered donee.

FIG. 3 is a schematic representation of a scenario where the registered donor enters the premises of the nonregistered donee. The system/method leverages location detection capabilities in the registered donor's mobile device to detect the nonregistered donee's premises, and the registered donor is prompted to donate money that will be kept in an escrow account for the nonregistered donee. The nonregistered donee is later notified of the money in the escrow account and sent an invitation with instructions on how to claim the funds.

FIG. 4 is a schematic representation of a scenario where a nonregistered donor enters the premises of a nonregistered donee. The GPS in the nonregistered donor's phone detects the premises of the nonregistered donee, and the nonregistered donor is prompted to download the application and donate money. After the nonregistered donor donates the money, he is directed to a link where he can submit his registration information. The money donated to the nonregistered donee is kept in an escrow account and an invitation containing information on how to claim the money is sent to the nonregistered donor.

FIGS. 5A-5D show screenshots of the display on the mobile device of the donor during the donation process.

### DETAILED DESCRIPTION OF THE INVENTION

### Description of the Preferred Embodiment

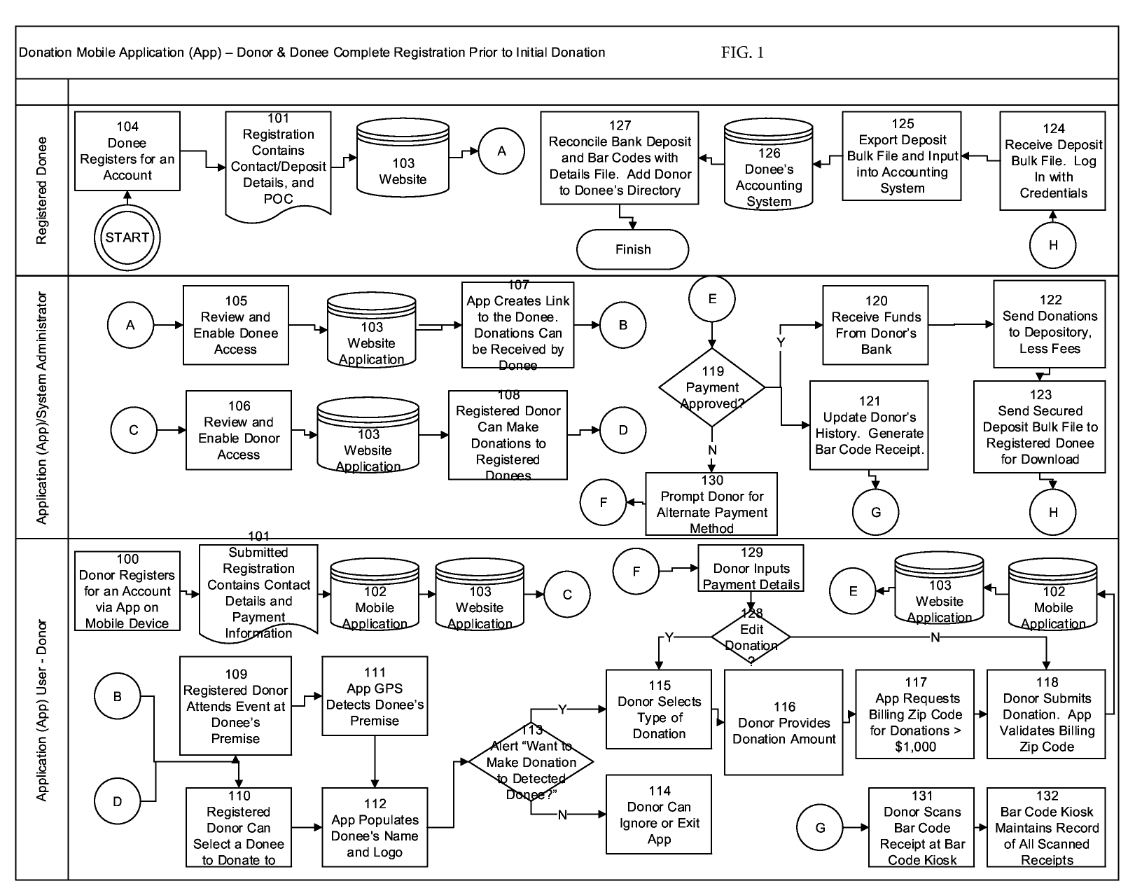

The preferred embodiment of this invention is illustrated in FIG. 1. This embodiment depicts a scenario where a registered donor enters into the premises of registered donee. The registered donee has registered prior to the donor entering into its premises and has become a registered donee. Likewise, the donor has registered before entering into the premises of the donee and has become a registered donor. In order for the donee to become registered, it has to visit a designate website and register to use the service (104). The registration information contains information such as the donee's public identification(s), contact information, bank account information, logo, and any relevant information such as the donor's credit or debit card information (101). The information is then transmitted to the website application 103. In an alternative embodiment, the registered donee is a church, nonprofit organization, fundraising entity, or any other entity that may like to receive money.

To approve the application of the nonregistered donee, the system administrator automatically reviews and enables nonregistered donee's access (105) and the information is transmitted to the website application 103. The website application then creates a link to the nonregistered donee's account and the nonregistered donee now becomes a registered donee, making it eligible to receive money (107).

Likewise, a nonregistered donor who intends to use the service downloads the application to his mobile device and, in doing so, submits registration information such as contact details and payment information (100, 101). The registration and contact information submitted is transmitted to the mobile application 102 and then to the website application 103.

In a related embodiment, the payment information is a credit card information, debit card information, or bank account information. In another related embodiment, the contact details are donor's name, address, social security number information, and driver license number.

The nonregistered donor's information is then routed to the computerized system administrator where it automatically enables the nonregistered donor's access (106), after which the information is now routed to the website application 103. After the nonregistered donor's application is approved, the nonregistered donor becomes a registered donor who can now donate money to the registered donee (108). At this juncture, both donor and donee are registered.

On, for example, a day of worship, the registered donor enters the premises of the registered donee, i.e., a church (109), and the GPS in the registered donor's mobile device coordinates with the system to detect the registered donee's premises. In a related embodiment, the donee's premises is verified through a geo location service such as Google location verification system. In a related embodiment, the donee's premises is verified using Yellow Pages technology for verifying location. Verifying the premises of the donee improves reliability, trust, and security. It should be noted, however, that other location detecting technologies may be used to detect and verify the donee's premises, as well as detect the location of the donor's mobile electronic device.

Once the GPS system has detected the premises of the registered donee (111), the application populates the registered donee's name and logo and prompts the registered donor to confirm that the registered donee is the appropriate recipient of the intended donation (112, 113).

Alternatively, the registered donor can elect to send donations to a registered donee whose premise is different from the one detected by the application. The donor does this by selecting the donee from the system's database (110, 112). The application then prompts the registered donor to verify that they are indeed interested in making a donation to the selected registered donee (113).

If the registered donor answers no, the registered donor can exit the application (114). If the registered donor answer is yes, the registered donor is given an option as to whether he or she wants to donate tithes, regular offering, or a special offering (115). The registered donor then selects the amount he wishes to donate or selects another amount, if donation amount is not listed (116).

In the event that the registered donor selects “Other Amount,” and that amount is greater than $1,000, the application requests the billing zip code of the registered donor (117). The registered donor now submits the donation and the application validates the billing zip code (118). After the validation is completed, the data is routed to the mobile application (102) and to the website application (103). The payment data from the website application will now be approved or disapproved (119). If the payment is disapproved, the registered donor is prompted to find an alternate method of payment or is directed to edit the payment details (129, 130). If the registered donor decides to edit the donation, he is asked again whether he intends to give a tithe or an offering (128, 115). If the registered donor decides not to edit the donation, he is routed to submit the donation (118).

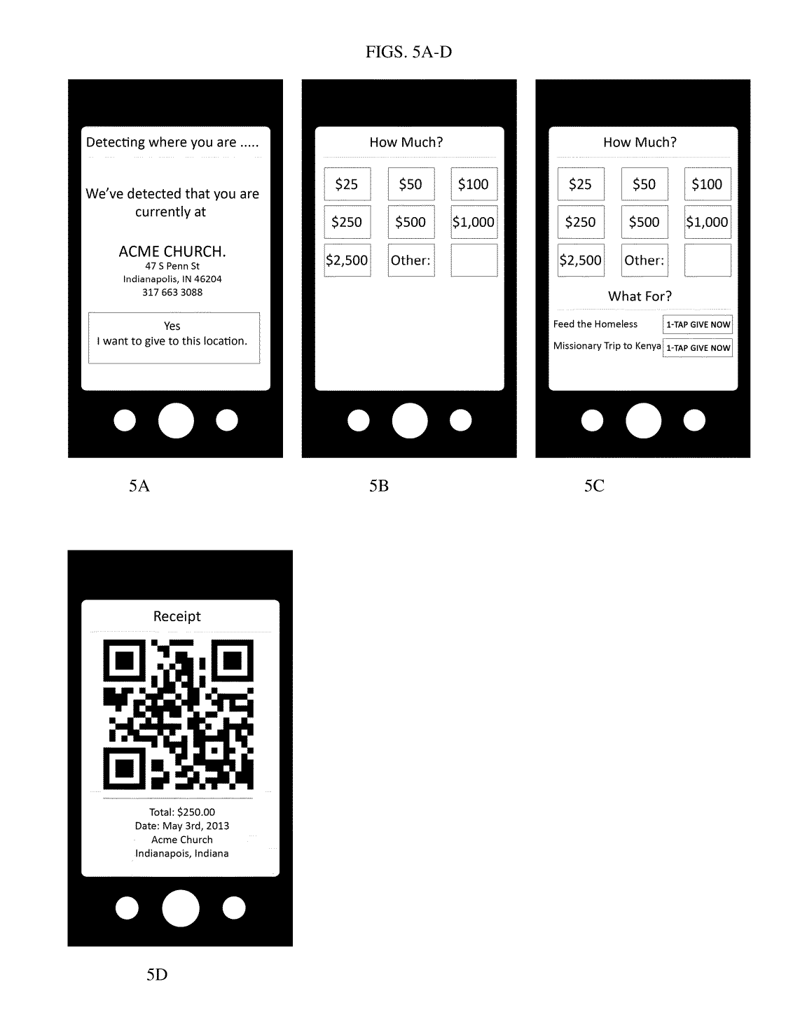

If, however, the payment is approved, the funds are retrieved from the registered donor's bank account and the registered donor's donation history is updated (120,121). The application now generates a barcoded receipt of the donation, which is displayed on the mobile device of the registered donor (121, FIG. 5D). To mimic the symbolic act of placing money in a bag, the registered donor may choose to display the barcode receipt in front of a barcode scanning device so that it can be scanned (131). The barcode scanning device keeps a record of all the scanned receipts (132). In an alternative embodiment, the barcode scanning device is a tablet pc, an Ipad, a laser scanning device, a PDA, or any mobile device with the ability to capture an image of a bar code while it is passed around like an offering bag so that the registered donor can scan their bar-coded receipts on it.

In another alternative embodiment, the barcode scanning device is a tablet pc, an Ipad, a laser scanning device, a PDA or any mobile device with the ability to capture an image of a bar code that is placed in front of the altar so that the registered donor can walk past the altar and scan the barcode device while doing so.

In another alternative embodiment, in lieu of scanning the barcode receipt to a barcode scanning device, the registered donee gives the registered donor a card on which the registered donor writes the donation amount, and the card is placed in the offering bag at the altar or when it is passed.

After the funds have been collected from registered donor's bank (120), the donations are sent to a registered depository, from which commissions and fees are subtracted, and a secured deposit bulk file or web link is sent to the registered donee for download/export (122, 123). The registered donee receives a deposit bulk file and a web link of the donations, and can log in to the website with its username and password (124) to view or verify all transactions. The registered donee exports the deposit bulk file details and inputs it into its accounting system (124, 125). The deposit bulk file is then routed to the registered donee's accounting system at stage 126. The bank deposit, bar code receipt details (FIG. 5D), the bulk file details, and the registered donor's name are reconciled, and the registered donor's name is added to the registered donee's directory (127).

### Description of Additional Embodiments

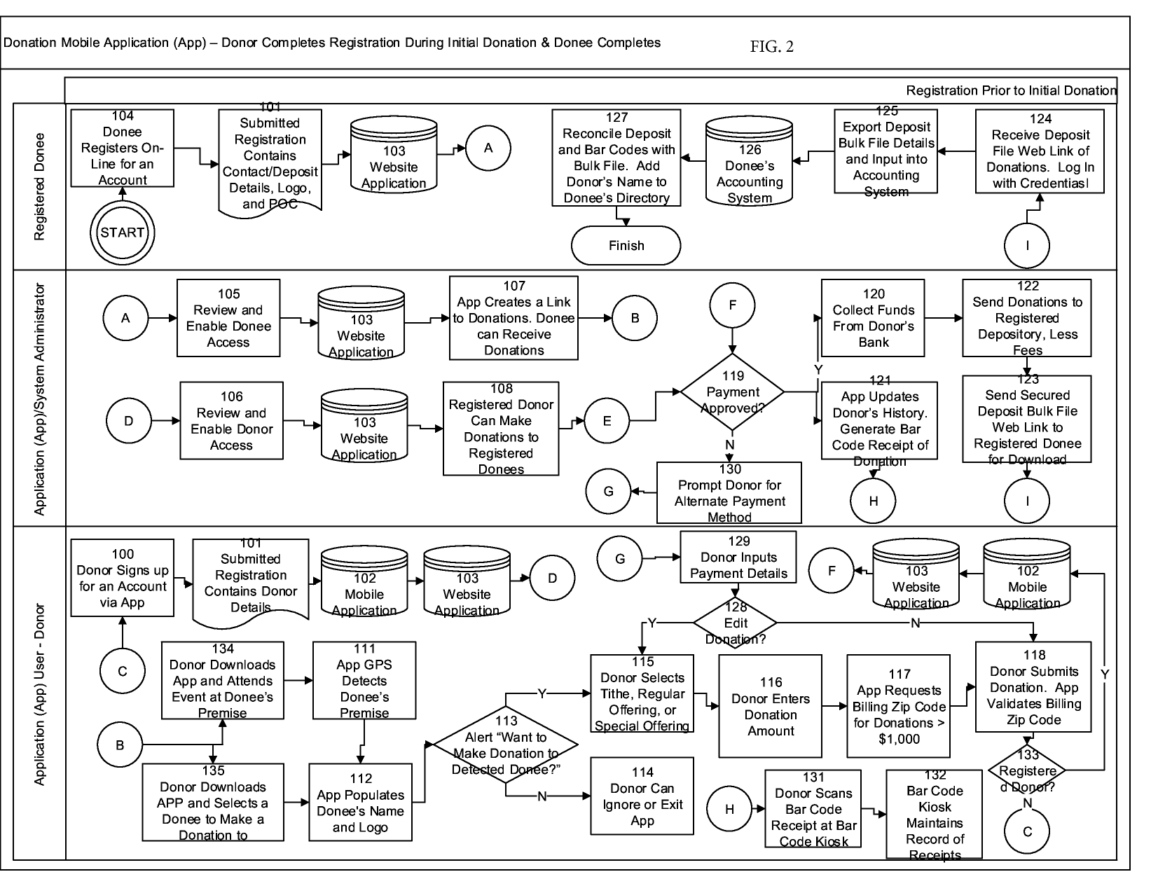

FIGS. 2-4 show a schematic representation of examples of the additional embodiments.

### EXAMPLE 1

FIG. 2 depicts a scenario where the donor has not downloaded the application and has not been registered before entering the premises of a donee that has been registered. In order for the donee to become registered, it has to visit a designated website and register to use the service (104). The registration information contains information such as the donee's contact information, public identification number, bank account information, logo, and any relevant information (101). The information is then transmitted to the website application 103. In an alternative embodiment, the registered donee is a church, nonprofit organization, fundraising entity, or any other entity that may like to receive money.

To approve the application of the nonregistered donee, the computerized system administrator automatically reviews and enables nonregistered donee's access (105) and the information is transmitted to the website application 103. The website application then creates a link to the nonregistered donee's account and the nonregistered donee now becomes a registered donee, making it eligible to receive money (107).

A nonregistered donor who is a worshipper enters the premises, i.e., church, of a registered donee and the nonregistered donor downloads the application to his mobile device (134, 135). The GPS and location reports (from the wireless service provider) in the nonregistered donor's mobile device detect the registered donee's premises (134, 111). In an alternative embodiment, the donee's premises is verified through a Google location verification system. In another alternative embodiment, the donee's premises is verified using Yellow Pages technology for verifying location. Verifying the premises of the registered donee improves reliability, trust, and security.

Once the system, aided by the GPS in the mobile device of the nonregistered donor, has detected the premises of the registered donee, it populates the registered donee's name and logo and prompts the nonregistered donor to verify that they are indeed interested in making donation to the selected registered donee (112, 113). If the nonregistered donor answers no, the registered donor can exit the application (114). If the nonregistered donor answer is yes, the nonregistered donor is given an option as to whether he or she wants to donate his tithe, regular offering, or special offering (115). The nonregistered donor then selects the amount he wishes to donate or selects another amount, if donation amount is not listed (116).

In the event that the nonregistered donor selects “Other Amount,” and that amount is greater than $1,000, the application requests the billing zip code of the nonregistered donor (117). The nonregistered donor now submits the donation by clicking the “Submit Donation” button; the application validates the billing zip code (118).

The application will now ask the user whether he is a registered donor (133). If the answer is no, the nonregistered donor is now directed to register for the service by submitting some required information (100). The registration and contact information submitted is transmitted to the mobile application 102 and then to the website application 103.

On the other hand, if the donor were a registered donor, the registered donor now submits the donation; the application validates the billing zip code (118). After the validation is completed, the data is routed to the mobile application 102 and to the website application 103. The payment data from the website application will now be approved or disapproved (119). If the payment is disapproved, the registered donor is prompted to find an alternate method of payment or is directed to edit the payment details (129, 130). If the registered donor decides to edit the donation, he is asked again whether he intends to give a tithe or an offering (115, 128). If the registered donor decides not to edit the donation, he is routed to submit the donation (118, 128).

If, however, the payment is approved, the funds are retrieved from the registered donor's bank account and the registered donor's donation history is updated (120,121). The application now generates a barcoded receipt of the donation, which is displayed on the screen of the mobile device of the registered donor (121, FIG. 5D). To mimic the symbolic act of placing money in a bag, the registered donor may choose to display the barcode receipt in front of a barcode scanning device so that it can be scanned (131). The barcode scanning device keeps a record of all the scanned receipts (132).

In an alternative embodiment, the barcode scanning device is a tablet pc, an Ipad, a laser scanning device, a PDA, or any mobile device with the ability to capture an image of a barcode that is passed around like an offering bag so that the registered donor can scan their barcoded receipts on it.

In another alternative embodiment, the barcode scanning device is a tablet pc, an Ipad, a laser scanning device, a PDA or any mobile device with the ability to capture an image of a bar code, that is placed in front of the altar so that the registered donor can walk past the altar and scan the barcode device while doing so.

In another alternative embodiment, in lieu of scanning the barcode receipt to a barcode scanning device, the registered donee gives the registered donor a card on which the registered donor writes the donation amount, and the card is placed in the offering bag at the altar or when it is passed.

After the funds have been collected from registered donor's bank (120), the donations are sent to a registered depository, from which commissions and fees are subtracted, and a secured deposit bulk file or web link is sent to the registered donee for download/export (122, 123). The registered donee receives a deposit bulk file and a web link of the donations, and can log in to the website with its username and password to view or verify all donations (124). The registered donee exports the deposit bulk file details and inputs it into its accounting system (124, 125). The deposit bulk file is then routed to the registered donee's accounting system at stage 126. The bank deposit, bar code receipt details, the bulk file details, and the registered donor's name are reconciled, and the registered donor's name is added to the registered donee's directory (127)

### EXAMPLE 2

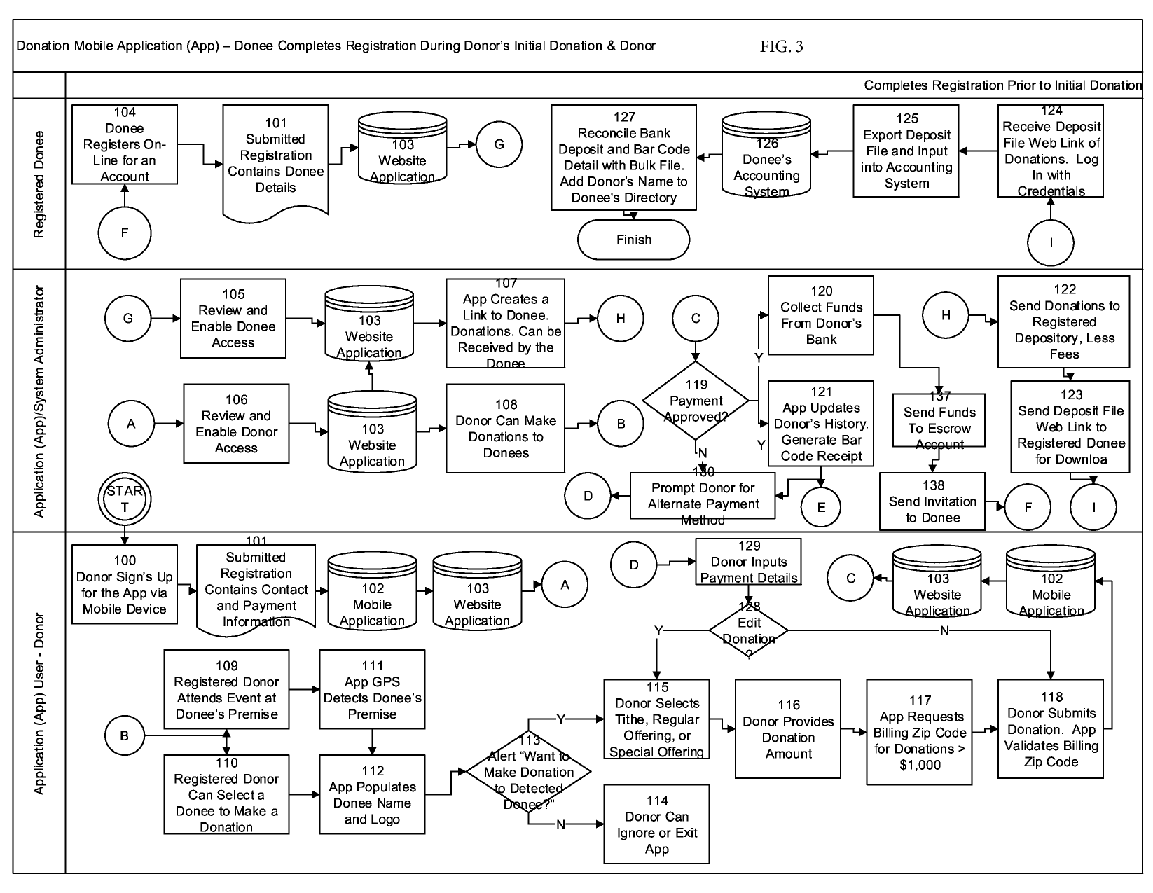

FIG. 3 shows another embodiment of the method and system for donating money to a donee. In this embodiment, a nonregistered donor who intends to use the service downloads the application to his mobile device and, in doing so, submits registration information such as contact details and payment information (100, 101). The registration and contact information submitted is transmitted to the mobile application 102 and then to the website application 103.

In a related embodiment, the payment information is a credit card information, debit card information, or bank account information. In another related embodiment, the contact details are donor's name, address, social security number information, and driver license number.

The nonregistered donor's information is then routed to the system administrator where it automatically enables the nonregistered donor's access (106), after which the information is now routed to the website application 103. After the nonregistered donor's application is approved, the nonregistered donor becomes a registered donor who can now donate money to the registered donee (108).

On, for example, a day of worship, the registered donor enters the premises of the registered donee, i.e., a church (109) the GPS and location reports (from the wireless service provider) in the registered donor's mobile device detect the registered donee's premises (111). In an alternative embodiment, the donee's premises is verified through a Google location verification system. In a related embodiment, the donee's premises is verified using Yellow Pages technology for verifying location. Verifying the premises of the donee ensures improves reliability, trust, and security.

Once the system has detected the premises of the nonregistered donee, it populates the nonregistered donee's name (no logo is populated since donee is not registered) and prompts the registered donor to verify that they are indeed interested in making donation to the selected nonregistered donee (111, 113).

Alternatively, the registered donor can elect to search for the nonregistered donee from the system's records (110). Once the registered donor has finished selecting the nonregistered donee, the system populates the nonregistered donee's name and the registered donor is prompted to verify that they are indeed interested in making a donation to the selected nonregistered donee (112, 113).

If the registered donor answers no, the registered donor can exit the application (114). If the registered donor's answer is yes, the registered donor is given an option as to whether he or she wants to donate tithes, regular offering, or a special offering (115). The registered donor then selects the amount he wishes to donate or selects another amount, if donation amount is not listed (116).

In the event that the registered donor selects “Other Amount,” and that amount is greater than $1,000, the application requests the billing zip code (117). The registered donor now submits the donation and the application validates the billing zip code (118). After the validation is completed, the data is routed to the mobile application 102 and to the website application 103.

The payment data from the website application will now be approved or disapproved (119). If the payment is disapproved, the registered donor is prompted to find an alternate method of payment or is directed to edit the payment details (129, 130). If the registered donor decides to edit the donation, he is asked again whether he intends to give a tithe or an offering (115). If the registered donor decides not to edit the donation, he is routed to submit the donation (118).

If, however, the payment is approved, the funds are retrieved from the registered donor's bank account and the registered donor's donation history is updated (120,121). The application now generates a barcoded receipt of the donation, which is displayed on the mobile device of the registered donor (121, FIG. 5D). To mimic the symbolic act of placing money in a bag, the registered donor may choose to display the barcode receipt in front of a barcode scanning device so that it can be scanned (131). The barcode scanning device keeps a record of all the scanned receipts (132).

In an alternative embodiment, the barcode scanning device is a tablet pc, an Ipad, a laser scanning device, a PDA or any mobile device with the ability to capture an image of a bar code that is passed around like an offering bag so that the registered donor can scan their barcoded receipts on it.

In another alternative embodiment, the barcode scanning device is a tablet pc, an Ipad, a laser scanning device, a PDA or any mobile device with the ability to capture an image of a bar code that is placed in front of the altar so that the registered donor can walk past the altar and scan the barcode device while doing so.

In another alternative embodiment, in lieu of scanning the barcode receipt to a barcode scanning device, the registered donee gives the registered donor a card on which the registered donor writes the donation amount, and the card is placed in the offering bag at the altar or when it is passed around.

After the funds have been collected from registered donor's bank account (120), if the donee is not registered, the funds are deposited to an escrow account (137), and an invitation on how to register is sent to the nonregistered donee (138). Upon receiving the invitation, the nonregistered donee visits a designated website and registers to use the service (104). The registration information contains information such as the donee's contact information, public identification number, bank account information, logo, and any relevant information (101). The information is then transmitted to the website application 103. In an alternative embodiment, the registered donee is a church, nonprofit organization, fundraising entity, or any other entity that may like to receive money.

To approve the application of the nonregistered donee, the computerized system administrator automatically reviews and enables nonregistered donee's access (105) and the information is transmitted to the website application 103. The website application then creates a link to the nonregistered donee's account and the nonregistered donee now becomes a registered donee, making it eligible to receive money (107).

If, on the other hand, the donee is registered, after the funds have been collected from registered donor's bank (120) the donations are sent to a registered depository, from which commissions and fees are subtracted, and a secured deposit bulk file or web link is sent to the registered donee for download/export (122, 123). The registered donee receives a deposit bulk file and a web link of the donations, and can log in to the website with its username and password (124). The registered donee exports the deposit bulk file details and inputs it into its accounting system (124, 125). The deposit bulk file is then routed to the registered donee's accounting system at stage 126. The bank deposit, bar code device detail, the bulk file details, and the registered donor's name are reconciled, and the registered donor's name is added to the registered donee's directory (127).

### EXAMPLE 3

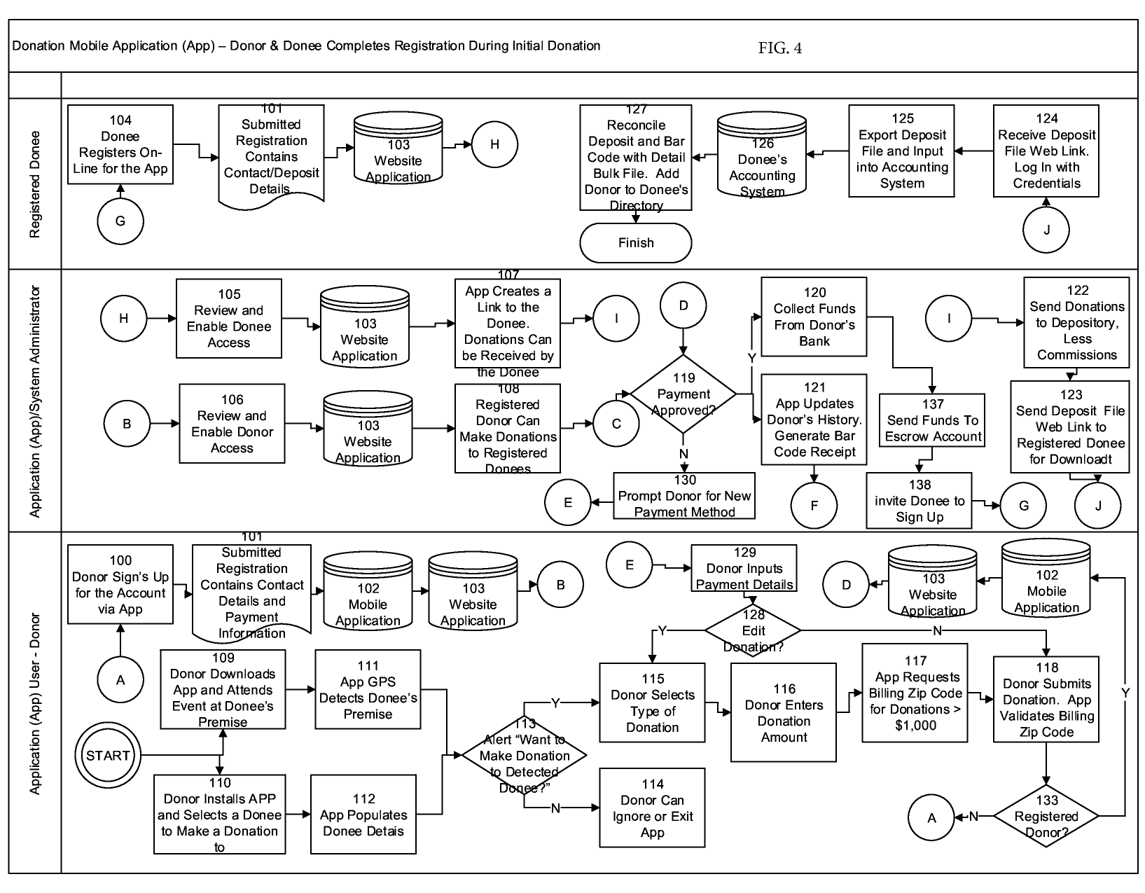

FIG. 4 depicts a scenario where a nonregistered donor enters the premises of a nonregistered donee and donation is still possible.

On, for example, a day of worship, the nonregistered donor enters the premises of the nonregistered donee, i.e., a church (109), and installs the application. The application uses the GPS and location reports (from the wireless service provider) in the mobile device of the nonregistered donor to detect the nonregistered donee's premises (111). In an alternative embodiment, the donee's premises is verified through a Google location verification system. In a related embodiment, the donee's premises is verified using Yellow Pages technology for verifying location. Verifying the premises of the donee ensures improves reliability, trust, and security.

Once the system has detected the premises of the nonregistered donee, it populates the nonregistered donee's name (no logo is populated since donee is not registered) and prompts the registered donor to verify that they are indeed interested in making donation to the selected nonregistered done (111, 113).

Alternatively, after installing the application on their mobile device, the nonregistered donor can elect to search for the nonregistered donee from the system's database (110). Once the nonregistered donor has finished selecting the nonregistered donee, the system populates the nonregistered donee's name and the nonregistered donor is prompted to verify that they are indeed interested in making donation to the selected nonregistered donee (112, 113).

If the nonregistered donor answers no, the registered donor can exit the application (114). If the nonregistered donor's answer is yes, the nonregistered donor is given an option as to whether he or she wants to donate his tithe, regular offering, or special offering (115). The nonregistered donor then selects the amount he wishes to donate or selects another amount, if donation amount is not listed (116).

In the event that the nonregistered donor selects “Other Amount,” and that amount is greater than $1,000, the application requests the billing zip code of the nonregistered donor (117). The nonregistered donor now submits the donation and the application validates the billing zip code (118).

The application will check for registration status of donor (133). If donor is not registered, he will be directed to register for the service by submitting some required information (100). The registration, contact, and payment information (101) submitted are transmitted to the mobile application 102 and then to the website application 103. On the other hand, if the donor were a registered donor, the payment data is routed to the mobile application 102 and to the website application 103 to begin the payment approval process.

The payment data from the website application will now be approved or disapproved (119). If the payment is disapproved, the registered donor is prompted to find an alternate method of payment or is directed to edit the payment details (129, 130). If the registered donor decides to edit the donation, he is asked again whether he intends to give a tithe or an offering (115). If the registered donor decides not to edit the donation, he is routed to submit the donation (118).

If, however, the payment is approved, the funds are retrieved from the registered donor's bank account and the registered donor's donation history is updated (120,121). The application now generates a barcoded receipt of the donation, which is displayed on the screen of the mobile device of the registered donor (121, FIG. 5D).

After the funds have been collected from the registered donor's bank account (120), since the donee is not registered, the funds are deposited to an escrow account (137), and an invitation on how to register is sent to the nonregistered donee. Upon receiving the invitation, the nonregistered donee visits a designated website and registers to use the service (104). The registration information contains information such as the donee's contact information, bank account information, logo, and any relevant information (101). The information is then transmitted to the website application 103. In an alternative embodiment, the registered donee is a church, nonprofit organization, fundraising entity, or any other entity that may like to receive money.

To approve the application of the nonregistered donee, the computerized system administrator automatically reviews and enables nonregistered donee's access (105) and the information is transmitted to the website application 103. The website application then creates a link to the nonregistered donee's account and the nonregistered donee now becomes a registered donee, making it eligible to receive money (107).

Once the donee becomes registered, the system releases donations from the escrow account and they are sent to a registered depository, from which commissions and fees are subtracted, and a secured deposit bulk file or web link is sent to the registered donee for download/export (122, 123). The registered donee receives a deposit bulk file and a web link of the donations, and can log in to the website with its username and password (124). The registered donee exports the deposit bulk file details and inputs it into its accounting system (124, 125). The deposit bulk file is then routed to the registered donee's accounting system at stage 126. The bank deposit, bar code device detail, the bulk file details, and the registered donor's name are reconciled, and the registered donor's name is added to the registered donee's directory (127). It should be noted that when the donor is asked to provide a validating information, such information could be the donor's banking information such as the donor's account number or credit or debit card information. The validating information could also be the donor's zip code, residential address, or social media login information, or it could be any identifying information that would be used to confirm the identity of the donor. The donor can also manually search for additional donees through a search function. The donor could search by state, zip code, city, or township, and donees listed within those parameters would be listed if they fall within the search parameters entered by the donor. Although the present invention is described by reference to the preferred embodiments and the examples disclosed, those embodiments and examples are not exhaustive and are meant to be illustrative. It is readily contemplated that modifications and combinations will be made by those skilled in the art, and the modifications and combinations will be within the spirit of the claims.

What we claim is:

1. A mobile electronic device-based method for sending money from a donor to a donee, said method comprising the steps of:
a) detecting the location of a mobile electronic device using means for detecting location;
b) detecting the locations of a donees that are in proximity of said mobile electronic device using means for detecting location and populating the list of said donees so that it is visible to said donor on said donor's mobile electronic device, wherein said donor is prompted to select the intended donee from said populated list and thereafter prompted to select the donation denomination, a validating information, and a donation amount from a plurality of donation amounts;
c) routing said donation amount first through a mobile application and then through a website application and, if said donation amount is approved, said donation amount is collected from donor's bank account and updated in donor's donation history;
d) generating a barcode receipt on the screen of said mobile electronic device so that is visible to the donor, depositing the donation amount to a registered depository less commission and fees, and sending a secured deposit bulk file web link to the donee for download or export; and
e) notifying said donee of said secured deposit bulk file web link via means for notifying and prompting said donee to access said link via a username and password and, upon a successful login, updating said donee's accounting system, reconciling each barcode receipt with the bulk file information, and adding donor's name to donee's donor directory.

2. The method as in claim 1, wherein said donor is a registered donor and said donee is a registered donee prior to detecting the locations of said mobile electronic device and said donee.

3. The method as in claim 1, wherein said donor is a nonregistered donor but said donee is a registered donee prior to detecting the locations of said donor and said donee.

4. The method as in claim 1, wherein said donor is a registered donor but said donee is a nonregistered donee prior to detecting the locations of said donor and said donee.

5. The method as in claim 1, wherein said donor is a registered donor and said donee is a nonregistered donee prior to detecting the locations of said mobile electronic device and said donee.

6. The method as in claim 1, wherein said validating information is selected from a group consisting of banking information, a zip code, residential address, social media login information, and the donor's residential number.

7. The method as in claim 1, wherein said donated amount is selected from a group consisting of a tithe, offering, instant donation, pledge, sponsorship, and a gift.

8. The method as in claim 1, wherein the location detecting means can be used by said donor to find information about additional donees not in the immediate proximity of said donor or said mobile electronic device.

9. The method as in claim 1, wherein the location detection means returns the state, city, zip code, township and allows said donor to manually search for donee within the returned state, city, zip code, or township.

10. The method as in claim 1, wherein said location detection means allows donor to optionally override the detected location and allows additional donees to be searchable by location.

11. The method as in claim 10, wherein said location is selected from a group consisting of city, state, zip code, and township.

12. The method as in claim 1, wherein said denomination is selected from a group consisting of United States Dollars, Canadian Dollars, and the European Euro.

13. The method as in claim 1, wherein said donation amount is a preconfigured amount.

14. The method as in claim 13, wherein said preconfigured amount is selected from a group consisting of $10, $25, $50, $100, $250, $500, and $1000.

15. The method as in clam 1, wherein said barcode receipt is readable by a scanning device, said scanning device is selected from a group consisting of a scanner, Ipad, Iphone, mobile phone, laser scanner, and an optical scanning device.

16. The method as in claim 1, further comprising generating a donor's donation history file at the end of the fiscal year that states the donor's tax-deductible donations from the non-tax-deductible donations.

17. A computer application software for sending money from a donor to a donee, readable by a mobile electronic device, comprising the steps of:
a) detecting the location of a mobile electronic device using means for detecting location;
b) detecting the locations of a donees that are in proximity of said mobile electronic device using means for detecting location and populating the list of said donees so that it is visible to said donor on said donor's mobile electronic device, wherein said donor is prompted to select the intended donee from said populated list and thereafter prompted to select the donation denomination, a validating information, and a donation amount from a plurality of donation amounts;
c) routing said donation amount first through a mobile application and then through a website application and, if said donation amount is approved, said donation amount is collected from donor's bank account and updated in donor's donation history;
d) generating a barcode receipt on the screen of said mobile electronic device so that is visible to the donor, depositing the donation amount to a registered depository less commission and fees, and sending a secured deposit bulk file web link to the donee for download or export; and
e) notifying said donee of said secured deposit bulk file web link via means for notifying and prompting said donee to access said link via a username and password and, upon a successful login, updating said donee's accounting system, reconciling each barcode receipt with the bulk file information, and adding donor's name to donee's donor directory.

18. A mobile electronic device-based method for sending money from a donor to a donee, said method comprising the steps of:
a) detecting the location of said mobile electronic device using means for location detection and detecting the locations of donees that are in proximity of said mobile electronic device using means for location detection and populating the list of said donees so that it is visible to said donor on said donor's mobile electronic device;
b) prompting said donor to select from the populated list of said nearby donees the name of the donee to whom donor intends to donate and prompting said donor to enter a donation amount, the donation denomination, and a validating information;
c) displaying the name of the donee the donor selected and prompting the donor to choose whether the donation is a tithe or offering;
d) displaying a donation amount of “$10,” “$25,” “$50,” “$100,” “$250,” “$500,” “$1,000,” and “other”; displaying whether the donation is for “tithe,” “offering,” or “other”; and prompting the donor to select from either the displayed donation amount and to select whether the donation is for a tithe, offering, or other, prompting the donor to add the selected donation amount to an envelope, and prompting the donor to optionally add another donation if the donor so desires; and
e) calculating the donation amount, prompting the donor to select “give now” to proceed with donating, and prompting the donor to sign for a new account or logon to an existing account.
